(19) United States
(12) Patent Application Publication
(10) Pub. No.: US 2010/0323053 A1
(43) Pub. Date: Dec. 23, 2010

(54) Roller Type Electrostatic Spinning Apparatus

(75) Inventors: Haw-Jer Chang, Hsinchuang City (TW); Jen-Hsiung Lee, Panchiao City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TAIWAN TEXTILE RESEARCH INSTITUTE, Tu-Chen City (TW)

(21) Appl. No.: 12/557,642

(22) Filed: Sep. 11, 2009

(30) Foreign Application Priority Data
Jun. 19, 2009 (TW) 98120635

(51) Int. Cl. B29C 47/32

(52) U.S. Cl. 425/174.8 E

(57) ABSTRACT

A roller type electrostatic spinning apparatus is disclosed, which includes an electrostatic spinning solution impregnation mechanism having a sizing roller, a linear emitting electrode disposed on the sizing roller, a collecting electrode module, and a high-voltage power supply. The collecting electrode module includes a casing, several exhaust vent disposed on the casing, several slits disposed on the casing, and several serrate collecting electrodes disposed next to the slits. The high-voltage power supply is connected to the linear emitting electrode and the serrate collecting electrodes.

### RELATED APPLICATIONS

This application claims priority to Taiwan Application Serial Number 98120635 filed Jun. 19, 2009, which is herein incorporated by reference.

### BACKGROUND

1. Field of Invention

The present invention relates to an electrostatic spinning apparatus. More particularly, the present invention relates to a roller type electrostatic spinning apparatus.

2. Description of Related Art

Electrostatic spinning technology can be used for manufacturing nanofibers. Electrostatic spinning technology provides a driving force generated by an electric field between an emitting electrode and a collecting electrode, so as to overcome surface tension and viscosity of the polymeric electrostatic spinning solution. In addition, fibers made by electrostatic spinning solution and spun from a spinneret repel each other because they are the same charge; when solvent evaporates, ultra-thin electrostatic spinning fibers can be formed.

Comparing to the fibers produced using prior spinning technology, the fabric made by electrostatic spinning method is featured by several properties, such as higher porosity, larger surface area, and smaller pore size than those of conventional textiles. The charged electrostatic spinning solution is spun to a collecting electrode from the spinneret. However, the aperture of the spinneret is very small and is easily blocked up by residual solution inside the spinneret. Moreover, the spinneret and pipe need to be cleaned when changing the electrostatic spinning solution. The applicability of the electrostatic spinning technique and the diversity of electrostatic spinning solutions are thus reduced.

TW Patent publication number 200827501 provides an electrostatic spinning apparatus, which is a roller type electrostatic spinning apparatus including a sizing roller and a linear emitting electrode to prevent unwanted block of spinneret. However, the threshold voltage of the roller type electrostatic spinning apparatus is higher than the conventional spinneret type electrostatic spinning apparatus, thus there is a need to decrease the threshold voltage of the roller type electrostatic spinning apparatus.

### SUMMARY

An embodiment of the invention provides a roller type electrostatic spinning apparatus. The roller type electrostatic spinning apparatus includes an electrostatic spinning solution impregnation mechanism, at least one linear emitting electrode, a collecting electrode module, and a high-voltage power supply. The electrostatic spinning solution impregnation mechanism includes a tank for containing an electrostatic spinning solution and a sizing roller rolled in the tank. The linear emitting electrode is disposed touching the sizing roller to coat the electrostatic spinning solution onto the linear emitting electrode. The collecting electrode module includes a casing, plural exhaust vents disposed on the casing, plural slits disposed on the casing and facing the electrostatic spinning solution impregnation mechanism, and plural serrate collecting electrodes disposed next to the slits. Each serrate collecting electrode includes plural protrusions arranged facing the electrostatic spinning solution impregnation mechanism. The high-voltage power supply is connected to the least one linear electrode and the serrate collecting electrodes respectively.

Another embodiment of the invention provides a collecting electrode module of a roller type electrostatic spinning apparatus. The collecting electrode module includes a casing, plural exhaust vents disposed on the casing, plural slits disposed on the casing and facing the electrostatic spinning solution impregnation mechanism, and plural serrate collecting electrodes disposed next to the slits. Each serrate collecting electrode has plural protrusions.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of an embodiment of the roller type electrostatic spinning apparatus of the invention;

FIG. 2 illustrates a side-view diagram of an embodiment of the collecting electrode module of the roller type electrostatic spinning apparatus of the invention; and

FIG. 3A and FIG. 3B illustrate different embodiments of the serrate collecting electrode in FIG. 2.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

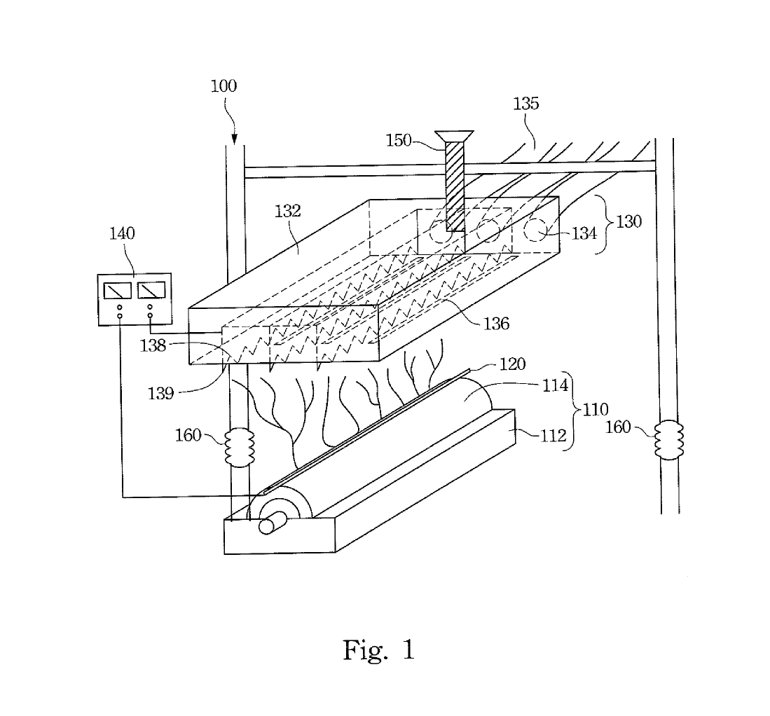

Refer to FIG. 1. FIG. 1 illustrates a schematic diagram of an embodiment of the roller type electrostatic spinning apparatus of the invention. The roller type electrostatic spinning apparatus 100 includes an electrostatic spinning solution impregnation mechanism 110, at least one linear emitting electrode 120, a collecting electrode module 130, and a high-voltage power supply 140. The electrostatic spinning solution impregnation mechanism 110 includes a tank 112 and a sizing roller 114. The electrostatic spinning solution is contained in the tank 112. The sizing roller 114 is rolled in the tank 112. The linear emitting electrode 120 is disposed touching the sizing roller 114, so that the electrostatic spinning solution contained in the tank 112 can be coated onto the linear emitting electrode 120.

The collecting electrode module 130 includes a casing 132, plural exhaust vents 134 disposed on the casing 132, plural slits 136 disposed on the casing 132, and plural serrate collecting electrodes 138 disposed next to the slits 136. The slits 136 and the serrate collecting electrodes 138 are disposed at the side of casing 132, which faces the electrostatic spinning solution impregnation mechanism 110. The serrate collecting electrodes 138 are one-to-one disposed next to the slits 136. The serrate collecting electrodes 138 are connected to each other in this embodiment. Each serrate collecting electrode 138 has plural protrusions 139, which are arranged face the electrostatic spinning solution impregnation mechanism 110. The collecting electrode module 130 includes an exhaust device 135 connected to the exhaust vents 134 to exhaust the air in the casing 132.

The high-voltage power supply 140 is connected to the linear emitting electrode 120 and the serrate collecting electrodes 138 to oppositely charge the linear emitting electrode 120 and the serrate collecting electrodes 138. In this embodiment, the linear emitting electrode 120 is charged positively and the serrate collecting electrodes 138 are charged negatively by the high-voltage power supply 140. The linear emitting electrode 120 may touch the sizing roller 114 to coat the electrostatic spinning solution contained in the tank 112 through the sizing roller 114 rolled in the tank 112. The electrostatic spinning solution on the linear emitting electrode 120 is repelled by the high-voltage like charge and may be separated from the sizing roller 114 and then scattered. The positively charged electrostatic spinning solution may be attracted by the negatively charged serrate collecting electrodes 138 and the electrostatic spinning solution may be led to the serrate collecting electrodes 138 and form an electrostatic spinning fiber. The electrostatic spinning fiber is collected by the collecting electrode module 130 to form an electrostatic spinning fabric.

The roller type electrostatic spinning apparatus 100 may have a height controller 150 connected to the collecting electrode module 130. The distance between the linear emitting electrode 120 and the collecting electrode module 130 can be adjusted by the height controller 150. The roller type electrostatic spinning apparatus 100 may also include plural high-voltage insulators 160 disposed between the linear emitting electrode 120 and the collecting electrode module 130 to prevent electric leakage while performing electrostatic spinning. The intensity of the electric field of the roller type electrostatic spinning apparatus 100 may be adjusted by the high-voltage power supply 140 and the height controller 150. The shorter distance between the linear emitting electrode 120 and the collecting electrode module 130; the stronger electric field between the linear emitting electrode 120 and the collecting electrode module 130. The higher voltage provided by the high-voltage power supply 140; the stronger electric field between the linear emitting electrode 120 and the collecting electrode module 130.

Each serrate collecting electrode 138 has plural protrusions 139 thereon, thus the threshold voltage to form the electrostatic spinning fiber of the embodiment can be decreased by point discharge effect to saving energy and provide better operation environment. In other words, the distance between the linear emitting electrode 120 and the collecting electrode module 130 can be increased while performing electrostatic spinning to better extent the electrostatic spinning fiber, so that the strength, the pore size, and the porosity of the electrostatic spinning fabric can be enhanced.

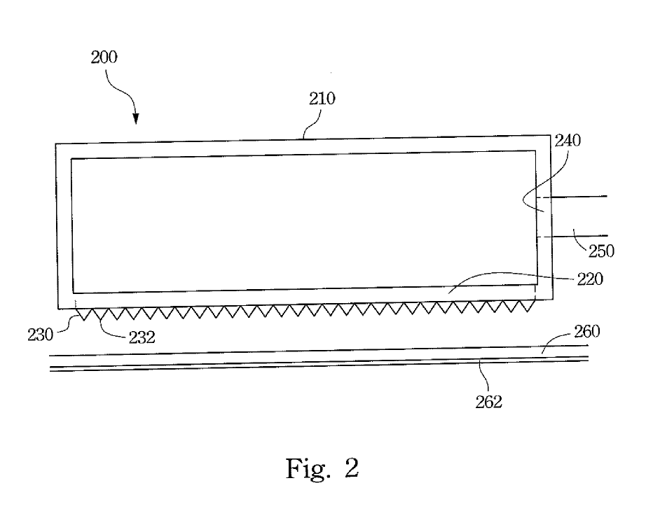

Refer to FIG. 2. FIG. 2 illustrates a side-view diagram of an embodiment of the collecting electrode module of the roller type electrostatic spinning apparatus of the invention. The collecting electrode module 200 includes the casing 210, the slits 220 disposed on the casing 210, the serrate collecting electrodes 230 disposed next to the slits 220, the exhaust vents 240 disposed on the casing 210, and the exhaust device 250 connected to the exhaust vents 240.

The material of the casing 210 is metal. The height of the casing 210 is about from 5 cm to 15 cm. The slits 220 are disposed parallel on the casing 210. The arrangement of the protrusions 232 of each serrate collecting electrode 230 is a linear arrangement, and the linear arrangement of the protrusions 232 is approximately parallel to the slits 220. The protrusions 232 of the serrate collecting electrode 230 are shaped as sawtooth. The protrusions 232 have the same height. The protrusions 232 are arranged equally. The height of the protrusions 232 is about from 0.5 mm to 100 mm. The distribution density of the protrusions 232 of the serrate collecting electrode 230 is from 2 protrusions per inch to 9 protrusions per inch. Namely, the number of the protrusions 232 distributed on the serrate collecting electrode 230 per inch is about from 2 to 9.

The collecting electrode module 200 may further include a conveyer belt 260 disposed under and passing through the casing 210. The conveyer belt 260 passes through the serrate collecting electrodes 230. The electrostatic spinning solution is led toward the serrate collecting electrodes 230 to form the electrostatic spinning fiber, and the electrostatic spinning fiber is collected on the conveyer belt 260. The conveyer belt 260 has a conveying direction to collect and convey the electrostatic spinning fibers. There might have a fabric 262 disposed on the conveyer belt 260, and the electrostatic spinning fibers may cover the fabric 262 to form a composite fabric.

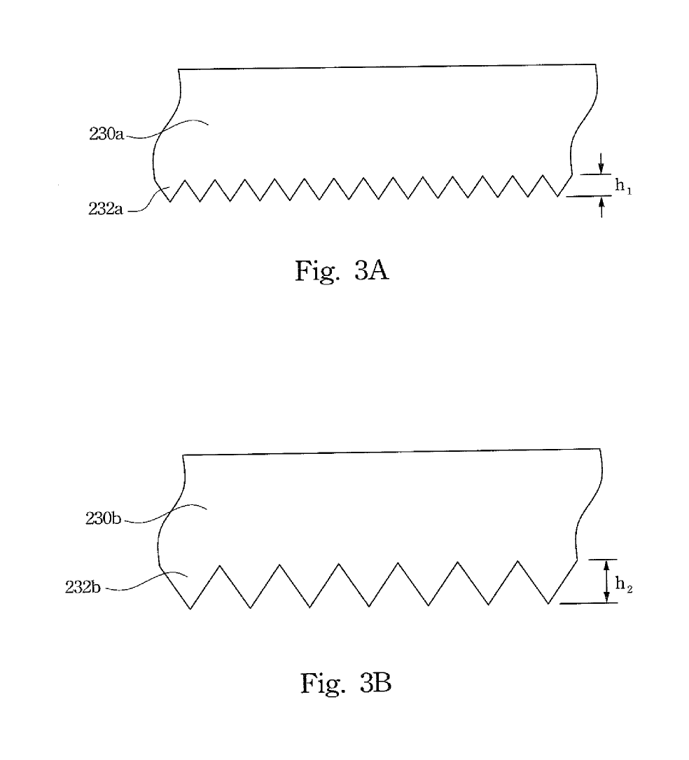

Refer to FIG. 3A and FIG. 3B. FIG. 3A and FIG. 3B illustrate different embodiments of the serrate collecting electrode in FIG. 2. The distribution destiny of the protrusions 232a on the serrate collecting electrode 230a in FIG. 3A is larger than the distribution destiny of the protrusions 232b on the serrate collecting electrode 230b in FIG. 3B. Namely, the serrate collecting electrode 230a in FIG. 3A has denser protrusions 232a, and the serrate collecting electrode 230b in FIG. 3B has sparser protrusions 232b. The height h₁ of the protrusions 232a in FIG. 3A is smaller than the height h₂ of the protrusions 232b in FIG. 3B

The height h₂ of the protrusions 232b in FIG. 3B is higher then the height h₁ of the protrusions 232a in FIG. 3A, thus the threshold voltage decrease of the electrostatic spinning process with the serrate collecting electrode 230b would be better than the threshold voltage decrease of the electrostatic spinning process with the serrate collecting electrode 230a.

A series of tests were run to distinguish the electrostatic spinning fiber made by the invention from the electrostatic spinning fiber made by the conventional plate-like collecting electrode. The term electrode distance used in below tables means the distance between the linear emitting electrode and the serrate collecting electrode (or the plate-like collecting electrode). The term threshold voltage used in the below tables means the lowest voltage to the electrostatic spinning fiber. The term electric breakdown voltage used in the below tables means an electric breakdown effect would be occurred at this voltage and was fail to form electrostatic spinning fiber. The term average fiber thickness used in the below tables means the average fiber thickness of the electrostatic spinning fibers formed from the threshold voltage to the electric breakdown voltage.

The material of the electrostatic spinning solution in Example 1 was PVA BF-17 (Chang Chun Group, TW), wherein the weight percent of the PVA BF 17 is 8%. The height of the protrusions of the serrate collecting electrode was 2 mm, and the distribution density of the protrusions was 9 protrusions per inch.

TABLE 1
Example 1 with different electrode distance

| | | | | | Average |
|---|---|---|---|---|---|
| | Type of | Electrode | Threshold | Electric | fiber |
| | collecting | distance | voltage | breakdown | thickness |
| | electrode | (cm) | (kV) | voltage (kV) | (nm) |
| Example | Plate-like | 6.5 | 63.6 | 70.5 | 290 |
| 1-1 | Serrate | | 50.2 | 69.3 | 207 |
| Example | Plate-like | 8.5 | 82.7 | 93.2 | 311 |
| 1-2 | Serrate | | 69.0 | 90.5 | 220 |
| Example | Plate-like | 10.5 | 98.5 | 118 | 322 |
| 1-3 | serrate | | 85.2 | 105 | 237 |

The material of the electrostatic spinning solution in Example 2 was PVA BF-17 (Chang Chun Group, TW), wherein the weight percent of the PVA BF 17 is 8%. The height of the protrusions of the serrate collecting electrode was 3 mm, and the distribution density of the protrusions was 9 protrusions per inch.

TABLE 2
Example 2 with different electrode distance

| | | | | | Average |
|---|---|---|---|---|---|
| | Type of | Electrode | Threshold | Electric | fiber |
| | collecting | distance | voltage | breakdown | thickness |
| | electrode | (cm) | (kV) | voltage (kV) | (nm) |
| Example | Plate-like | 6.5 | 63.6 | 70.5 | 290 |
| 2-1 | Serrate | | 49.1 | 67.8 | 212 |
| Example | Plate-like | 8.5 | 82.7 | 93.2 | 311 |
| 2-2 | Serrate | | 69.3 | 88.9 | 232 |
| Example | Plate-like | 10.5 | 98.5 | 118 | 322 |
| 2-3 | serrate | | 82.9 | 102.2 | 240 |

The material of the electrostatic spinning solution in Example 1 was PVA BF-17 (Chang Chun Group, TW), wherein the weight percent of the PVA BF 17 is 8%. The height of the protrusions of the serrate collecting electrode was 2 mm, and the distribution density of the protrusions was 6 protrusions per inch.

TABLE 3
Example 3 with different electrode distance

| | | | | | Average |
|---|---|---|---|---|---|
| | Type of | Electrode | Threshold | Electric | fiber |
| | collecting | distance | voltage | breakdown | thickness |
| | electrode | (cm) | (kV) | voltage (kV) | (nm) |
| Example | Plate-like | 6.5 | 63.6 | 70.5 | 290 |
| 3-1 | Serrate | | 54.0 | 69.6 | 216 |
| Example | Plate-like | 8.5 | 82.7 | 93.2 | 311 |
| 3-2 | Serrate | | 73.9 | 92 | 235 |
| Example | Plate-like | 10.5 | 98.5 | 118 | 322 |
| 3-3 | serrate | | 87.8 | 108 | 243 |

According to the Example 1, Example 2, and Example 3, the electrostatic spinning process with the serrate collecting electrode could provide thinner electrostatic spinning fibers and reduce the threshold voltage than the electrostatic spinning process with plate-like collecting electrode.

Refer to Example 1 and the Example 2. The height of the protrusions of the serrate collecting electrode was 2 mm in Example 1. The height of the protrusions of the serrate collecting electrode was 3 mm in Example 2. The reduction of the threshold voltage in Example 2 was approximately better than the reduction of the threshold voltage in Example 1. The thickness of the electrostatic spinning fiber in Example 1 was approximately thinner than the thickness of the electrostatic spinning fiber in Example 2.

Refer to Example 1 and Example 3. The distribution density of the protrusions of the serrate collecting electrode in Example 1 was 9 protrusions per inch. The distribution density of the protrusions of the serrate collecting electrode in Example 3 was 6 protrusions per inch. The reduction of the threshold voltage and the thickness of the electrostatic spinning fiber in Example 1 were approximately better than the reduction of the threshold voltage and the thickness of the electrostatic spinning fiber in Example 3.

According to the above embodiments, the roller type electrostatic spinning apparatus use the serrate collecting electrode with the protrusions thereon to reduce the threshold voltage while forming the electrostatic spinning fibers. Moreover, the roller type electrostatic spinning apparatus of the embodiments may utilize the linear electrode to substitute conventional spinneret, then the block of the spinneret or the pipe may be prevented.

Although the present invention has been described in considerable detail with reference to certain preferred embodiments thereof, other embodiments are possible. Therefore, the spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A roller type electrostatic spinning apparatus comprising:
an electrostatic spinning solution impregnation mechanism comprising a tank for containing an electrostatic spinning solution and a sizing roller rolled in the tank;
at least one linear emitting electrode disposed touching the sizing roller to coat the electrostatic spinning solution onto the least one linear emitting electrode;
a collecting electrode module comprising:
a casing;
a plurality of exhaust vents disposed on the casing;
a plurality of slits disposed on the casing and facing the electrostatic spinning solution impregnation mechanism; and
a plurality of serrate collecting electrodes disposed next to the slits, each serrate collecting electrode comprising a plurality of protrusions arranged facing the electrostatic spinning solution impregnation mechanism; and
a high-voltage power supply connected to the least one linear electrode and the serrate collecting electrodes respectively.

2. The roller type electrostatic spinning apparatus of claim 1, wherein an arrangement of the protrusions of each serrate collecting electrode is a linear arrangement.

3. The roller type electrostatic spinning apparatus of claim 2, wherein a number of the protrusions per inch is from 2 to 9.

4. The roller type electrostatic spinning apparatus of claim 1, wherein each protrusion has same height.

5. The roller type electrostatic spinning apparatus of claim 4, wherein the height of each protrusion is from 0.5 mm to 100 mm.

6. The roller type electrostatic spinning apparatus of claim 1, further comprising an exhaust device connected to the exhaust vents.

7. The roller type electrostatic spinning apparatus of claim 1, wherein the serrate collecting electrodes are one-to-one disposed next to the slits.

8. The roller type electrostatic spinning apparatus of claim 1, wherein the collecting electrode module comprises a conveyer belt passing through the casing to collect an electrostatic spinning fiber formed by the electrostatic spinning solution.

9. The roller type electrostatic spinning apparatus of claim 8, further comprising a fabric disposed on the conveyer belt, wherein the electrostatic spinning fiber is covered on the fabric to form a composite fabric.

10. The roller type electrostatic spinning apparatus of claim 1, wherein a material of the casing is metal.

11. The roller type electrostatic spinning apparatus of claim 1, wherein a height of the casing is from 5 cm to 15 cm.

12. The roller type electrostatic spinning apparatus of claim 1, further comprising a plurality of high-voltage insulators disposed between the least one linear emitting electrode and the collecting electrode module to prevent electric leakage.

13. The roller type electrostatic spinning apparatus of claim 1, further comprising a height controller connected to the collecting electrode module to control a distance between the sizing roller and the collecting electrode module.

14. A collecting electrode module of a roller type electrostatic spinning apparatus, the collecting electrode module comprising:
a casing;
a plurality of exhaust vents disposed on the casing;
a plurality of slits disposed on the casing and facing the electrostatic spinning solution impregnation mechanism; and
a plurality of serrate collecting electrodes disposed next to the slits, each serrate collecting electrode comprising a plurality of protrusions.

15. The collecting electrode module of the roller type electrostatic spinning apparatus of claim 14, wherein an arrangement of the protrusions of each serrate collecting electrode is a linear arrangement.

16. The collecting electrode module of the roller type electrostatic spinning apparatus of claim 15, wherein a number of the protrusions per inch is from 2 to 9.

17. The collecting electrode module of the roller type electrostatic spinning apparatus of claim 14, wherein each protrusion has same height.

18. The collecting electrode module of the roller type electrostatic spinning apparatus of claim 17, wherein the height of each protrusion is from 0.5 mm to 100 mm.

19. The collecting electrode module of the roller type electrostatic spinning apparatus of claim 14, wherein the serrate collecting electrodes are one-to-one disposed next to the slits.

20. The collecting electrode module of the roller type electrostatic spinning apparatus of claim 14, further comprising a conveyer belt passing through the casing for collecting an electrostatic spinning fiber.
